(19) United States
(12) Patent Application Publication
(10) Pub. No.: US 2024/0119528 A1
(43) Pub. Date: Apr. 11, 2024

(54) AUTOMATED SYSTEMS AND METHODS FOR SELECTING FUND ALLOCATIONS FOR INVESTMENT ACCOUNTS

(71) Applicant: LeafHouse Financial Services, LLC, Austin, TX (US)

(72) Inventors: Dale Homburg, Austin, TX (US); Todd Kading, Austin, TX (US); Michael Garberich, Austin, TX (US)

(21) Appl. No.: 17/938,808

(22) Filed: Oct. 7, 2022

(51) Int. Cl. G06Q 40/06; G06Q 40/02

(52) U.S. Cl. CPC G06Q 40/06; G06Q 40/02

(57) ABSTRACT

Automated systems and methods for selecting fund allocations for investment accounts are disclosed. An automated system includes an allocation database and a fallback database that includes fallback fund categories for target fund categories. A database processor is configured to retrieve a selected target-allocation sub-table from the allocation database for a participant. For each target fund category in the selected target-allocation sub-table, an application processor is configured to assign the target allocation to a sole matching fund in response to determining a number of matching funds is one. The application processor is configured to select a selected matching fund based on a comparison of fund scores in response to determining the number of matching funds is two or more. The application processor is configured to retrieve a selected fallback fund category from the fallback database in response to determining the number of matching funds is zero.

### TECHNICAL FIELD

The instant disclosure relates generally to investment accounts and, more particularly but without limitation, to automated systems and methods for selecting fund allocations for investment accounts.

### BACKGROUND

Investment accounts are important. They allow an investor to plan for their future by holding assets, such as securities, for the investor. An investor may be an individual retail investor (e.g., a person) or an institutional investor (e.g., an organization such as a university). The value of the assets in the investment account may grow over time in a manner that provides the investor with long-term financial stability and security. In the United States, there are a number of types of investment accounts, such as individual retirement accounts (IRAs), which are tax-advantaged accounts for retirement; 401(k)s, which are tax-advantaged accounts for retirement that are offered by employers; health savings accounts (HSAs), which are tax-advantaged account for medical expenses; 529 plans, which are tax-advantaged account for education expenses; and brokerage accounts, which are non-tax-advantaged investment accounts.

For each type of account, an investor has a large number of accounts from which to choose. Additionally, once an account is chosen, the investor has a large number of categories of funds from which to choose for investment. For instance, within an account, an investor may choose to invest money in one or more of hundreds of types of fund categories, such as commodities-focused funds, currency, digital assets, emerging markets, municipal bonds, large blend funds, large growth funds, large value funds, real estate, small blend funds, small growth funds, small value funds, etc. Once a fund category is selected, the investor may have a large number of funds from which to choose within the fund category.

All of these choices can be overwhelming. To avoid having to personally pick from all of these options, an investor may select to use a managed account. With a managed account, the account is managed by another party on behalf of the investor that owns the account. The party managing the account may a professional money manager or a robo-advisor. Additionally, the managed account may be in the form of a mutual fund that is managed by a fund company. The managing party decides for the investor in which types of accounts to invest, how to distribute the investor's money among the various selected account types, which fund categories to select within the various selected account types, how to distribute the investor's money among the various selected fund categories, which funds to select for the various selected fund categories, etc.

In some instances, the managing party may attempt to personalize the managed account for the investor. For instance, the managing party may select particular types of investment funds based on the living situation of the investor. The types of investment funds selected by the managing party may depend on the current age of the investor, the expected retirement age of the investor, whether the investor has children, the amount of debt held by the investor, etc.

Oftentimes, personalizing a managed account for an investor may require a significant amount of manual effort by the managing party. For instance, in order to simplify the selection of a fund, a managing party may use a rigid list of target fund categories when selecting funds for those categories. A managing party may limit the number of funds from which to choose for a particular fund category to simplify the selection and distribution process.

Oftentimes, upon identifying that there are no funds within the shortened list that satisfy the rigid checklist for selection of funds, a managing party may use a Byzantine and labor-intensive sequence for investing that money in an alternative fund, which may delay the investment of funds by months. Additionally, recordkeepers, for example, may frequently reclassify the categories for which some funds are designated. When this occurs, a fund previously selected for a particular category may no longer be designated for that category. In turn, the Byzantine and labor-intensive sequence for selecting an alternative fund may need to be used, thereby again delaying the investment of funds by months.

Furthermore, upon identifying that there are multiple funds within the shortened list that satisfy the rigid checklist for selection of funds, a managing party may also find it difficult to determine which, if any, of those funds outperforms the others. Because of this difficulty, managing parties oftentimes spread money allocated for a particular fund category across all of the funds available within that fund category. The spreading of funds in such a manner may also increase overhead costs by increasing the number of funds that are traded.

Thus, parties managing managed accounts may have difficulty developing a personalized portfolio for an investor in a manner that optimizes the returns for the investor.

### SUMMARY

Disclosed are example automated systems and methods for selecting fund allocations for an investment account.

An example automated system for selecting fund allocations for an investment account includes a database server. The database server includes an allocation database having one or more allocation tables. Each of the one or more allocation tables includes a plurality of cells. Each of the plurality of cells includes a target-allocation sub-table that includes target fund categories and respective target allocations. The database server includes a fallback database that includes fallback fund categories for the target fund categories. One or more of the fallback fund categories is designated for each of the target fund categories. For each target fund category, each corresponding fallback fund category is formed from one or more substitute fund categories. The database server includes one or more database processors configured to, in real-time upon a request for a participant, collect an age of the participant; determine a risk tolerance of the participant; and retrieve a selected target-allocation sub-table from the allocation database based on, at least in part, the age and the risk tolerance of the participant. The automated system includes an application server. The application server includes memory configured to store an available-funds table that includes an identifier code, a fund category, and a fund score for each available fund. The application server includes one or more application processors. For each of the target fund categories in the selected target-allocation sub-table, the one or more application processors is configured to, in real-time upon the request for the participant, determine a number of matching funds within the available-funds table that correspond with the target fund category; in response to determining the number of matching funds being one, assign a target allocation for the target fund category to a sole matching fund; in response to determining the number of matching funds being two or more, select a selected matching fund based on a comparison of the fund score of each matching fund and assign the target allocation to the selected matching fund; and in response to determining the number of matching funds being zero, select a selected fallback fund category from the fallback database and assign the target allocation among the one or more substitute fund categories that form the selected fallback fund category. The one or more application processors is configured to, in real-time upon the request for the participant, generate and transmit an allocation list that identifies an allocation amount assigned to each available fund selected for fund allocation.

In some examples, each of the one or more allocation tables of the allocation database corresponds with a different combination of fund categories. In some such examples, the one or more database processors is configured to collect an allocation methodology selection, select a selected allocation table from the one more allocation tables based on the allocation methodology selection, and retrieve the selected target-allocation sub-table from the selected allocation table.

In some examples, the one or more application processors of the application server is configured to collect a list of offered funds and generate the available-funds table based on the list of offered funds. The list of offered funds includes identifier codes for respective offered funds. In some such examples, the database server further includes a fund database configured to store fund categories, identifier codes, and fund scores for identifiable funds. The fund database is configured to store a fund category, one or more of the identifier codes, and one or more of the fund scores for each of the identifiable funds. Further, in some such examples, for each offered fund within the list of offered funds, the one or more database processors is configured to identify the offered fund by comparing the identifier code of the offered fund to the identifier codes stored within the fund database; and add the identifier code, the fund category, and one of the one or more fund scores of the offered fund that has been identified to the available-funds table. Additionally, in some such examples, the fund database is configured to include a plurality of fund code types. To identify each offered fund, the one or more database processors are configured to compare the identifier code of the offered fund to the identifier codes of a first fund code type that are stored within the fund database; and in response to determining that the identifier code of the offered fund does not match any of the identifier codes of the first fund code type, compare the identifier code of the offered fund to the identifier codes of another fund code type that are stored within the fund database. Additionally, in some such examples, the fund database is configured to include a plurality of scoring systems. The one or more database processors are configured to collect a scoring system selection and select which of the one or more fund scores to add to the available-funds table based on the scoring system selection.

In some examples, to select the selected matching fund for one of the target fund categories, the one or more application processors is configured to select a first matching fund that has a greatest score among matching funds as the selected matching fund for allocation. In some such examples, in response to determining that two or more of the matching funds are tied for having the greatest score among the matching funds, the one or more application processors is configured to compare fund information ratios of the two or more of the matching funds as a tiebreaker to select the selected matching fund for allocation. Further, in some such examples, the one or more application processors is configured to randomly select the selected matching fund for allocation in response to identifying a tie between the fund information ratios.

In some examples, the fallback database includes a respective primary fallback fund category for each of the target fund categories and includes a respective secondary fallback fund category for one or more of the target fund categories.

In some examples, the substitute fund categories of the fallback database include one or more of the target fund categories. One or more of the fallback fund categories includes a combination of two or more of the substitute fund categories each of which is designated a portion of the target allocation for the respective target fund category.

In some examples, for each of the target fund categories, the one or more database processors is configured to select a primary fallback fund category in response to the one or more application processors determining that the available-funds table includes an available fund for each of the one or more substitute fund categories that form the primary fallback fund category; determine whether to select a secondary fallback fund category in response to the one or more application processors determining that there is no available fund in the available-funds table for at least one of the one or more substitute fund categories forming the primary fallback fund category; and select the secondary fallback fund category in response to the one or more application processors determining that the available-funds table includes an available fund for each of the one or more substitute fund categories that form the secondary fallback fund category.

In some examples, in response to determining that an available fund is selected for two or more of the target fund categories, add the corresponding allocation amounts together when generating the allocation list.

An example automated method for selecting fund allocations for an investment account includes operating an allocation database of a database server. The allocation database has one or more allocation tables. Each of the one or more allocation tables includes a plurality of cells. Each of the plurality of cells includes a target-allocation sub-table that includes target fund categories and respective target allocations. The automated method includes operating a fallback database of the database server. The fallback database includes fallback fund categories for the target fund categories. One or more of the fallback fund categories is designated for each of the target fund categories. For each target fund category, each corresponding fallback fund category is formed from one or more substitute fund categories. The automated method includes collecting, via one or more database processors of the database server, an age of a participant in real-time upon a request for the participant and determining, via the one or more database processors, a risk tolerance of the participant in real-time upon the request for the participant. The automated method includes retrieving, in real-time upon the request for the participant, a selected target-allocation sub-table from the allocation database based on, at least in part, the age and the risk tolerance of the participant. The automated method includes storing, in memory of an application server, an available-funds table that includes an identifier code, a fund category, and a fund score for each available fund. The automated method includes, for each of the target fund categories in the selected target-allocation sub-table and in real-time upon the request for the participant, determining, via one or more application processors of the application server, a number of matching funds within the available-funds table that correspond with the target fund category; in response to the number of matching funds being one, assigning a target allocation for the target fund category to a sole matching fund; in response to the number of matching funds being two or more, selecting a selected matching fund based on a comparison of the fund score of each matching fund and assigning the target allocation to the selected matching fund; and, in response to the number of matching funds being zero, selecting a selected fallback fund category from the fallback database and assigning the target allocation among the one or more substitute fund categories that form the selected fallback fund category. The automated method includes generating and transmitting, via the one or more application processors, an allocation list that identifies an allocation amount assigned to each available fund selected for fund allocation.

In some examples, selecting the selected matching fund for one of the target fund categories includes selecting a first matching fund that has a greatest score among matching funds as the selected matching fund for allocation; in response to determining that two or more of the matching funds are tied for having the greatest score among the matching funds, comparing fund information ratios of the two or more of the matching funds as a tiebreaker to select the selected matching fund for allocation; and randomly selecting the selected matching fund for allocation in response to identifying a tie between the fund information ratios.

In some examples, the substitute fund categories of the fallback database include one or more of the target fund categories. One or more of the fallback fund categories includes a combination of two or more of the substitute fund categories each of which is designated a portion of the target allocation for the respective target fund category.

Some examples further include, for each of the target fund categories, selecting a primary fallback fund category in response to determining that the available-funds table includes an available fund for each of the one or more substitute fund categories that form the primary fallback fund category, determining whether to select a secondary fallback fund category in response to determining that there is no available fund in the available-funds table for at least one of the one or more substitute fund categories forming the primary fallback fund category, and selecting the secondary fallback fund category in response to the one or more application processors determining that the available-funds table includes an available fund for each of the one or more substitute fund categories that form the secondary fallback fund category.

Example computer readable media comprising instructions, which, when executed, cause one or more machines to collectively operate an allocation database of a database server. The allocation database has one or more allocation tables. Each of the one or more allocation tables includes a plurality of cells. Each of the plurality of cells includes a target-allocation sub-table that includes target fund categories and respective target allocations. The instructions, which, when executed, cause the one or more machines to collectively operate a fallback database of the database server. The fallback database includes fallback fund categories for the target fund categories. One or more of the fallback fund categories is designated for each of the target fund categories. For each target fund category, each corresponding fallback fund category is formed from one or more substitute fund categories. The instructions, which, when executed, cause the one or more machines to collectively collect an age of a participant in real-time upon a request for the participant and determine a risk tolerance of the participant in real-time upon the request for the participant. The instructions, which, when executed, cause the one or more machines to collectively retrieve, in real-time upon the request for the participant, a selected target-allocation sub-table from the allocation database based on, at least in part, the age and the risk tolerance of the participant. The instructions, which, when executed, cause the one or more machines to collectively store an available-funds table that includes an identifier code, a fund category, and a fund score for each available fund. The instructions, which, when executed, cause the one or more machines to collectively, for each of the target fund categories in the selected target-allocation sub-table and in real-time upon the request for the participant, determine a number of matching funds within the available-funds table that correspond with the target fund category; in response to the number of matching funds being one, assign a target allocation for the target fund category to a sole matching fund; in response to the number of matching funds being two or more, select a selected matching fund based on a comparison of the fund score of each matching fund and assign the target allocation to the selected matching fund; and in response to the number of matching funds being zero, select a selected fallback fund category from the fallback database and assign the target allocation among the one or more substitute fund categories that form the selected fallback fund category. The instructions, which, when executed, cause the one or more machines to collectively generate and transmit an allocation list that identifies an allocation amount assigned to each available fund selected for fund allocation.

### BRIEF DESCRIPTION OF THE DRAWINGS

FIG. 1 depicts an example environment in which fund allocations are selected in an automated manner for managed investment accounts.

FIG. 2 depicts an example automated system for selecting fund allocations within the environment of FIG. 1 in accordance with the teachings herein.

FIG. 3 is an example flowchart for selecting fund allocations for managed investment accounts in an automated manner.

FIG. 4 is an example flowchart for generating a table of funds of a recordkeeper that are available to a participant.

FIG. 5 is an example flowchart for retrieving a target-allocation sub-table for a participant.

FIG. 6 is an example flowchart for identifying fund category allocations and selecting available funds for the fund category allocations for a participant.

FIG. 7 is an example flowchart for accessing a fallback database to assign a target allocation to one or more substitute fund categories forming a fallback fund category.

FIG. 8 is an example flowchart for assigning a target allocation to an available fund for a target fund category.

FIG. 9 depicts an example list of funds offered for a participant.

FIG. 10 depicts an example fund database.

FIG. 11 depicts an example list of funds available to a participant.

FIG. 12 depicts an example allocation database.

FIG. 13 depicts an example target-allocation sub-table of the allocation database of FIG. 12.

FIG. 14 depicts an example fallback table.

### DETAILED DESCRIPTION

While the features, methods, devices, and systems described herein may be in various forms, some non-limiting examples are shown in the drawings and are described hereinafter. However, not all of the depicted components described in this disclosure may be required, and some implementations may include additional, different, or fewer components from those expressly described in this disclosure. Variations in the arrangement and type of the components may be made without departing from the spirit or scope of the claims as set forth herein.

The instant disclosure describes and illustrates various examples of an automated system and an automated method configured to create a personalized distribution of funds in order to optimize returns of a managed investment account of an investor by selecting (1) fund categories and corresponding fund allocations based on characteristics of the participant 100 and (2) particular funds for those fund categories based on fund performance scores. Example systems and methods disclosed herein are directed to a specification implementation of a limited set of rules that account managers have not utilized for investment selections, either manually or by those in search of automated processes. Because there are hundreds of thousands of funds from which to choose and a number of different coding systems used to identify those funds, the specific set of rules provide a technical improvement over existing techniques within the financial technology (“fintech”) field for managed accounts (e.g., managed retirement accounts) by systematically and accurately identifying funds based on a list of identifier codes provided by a recordkeeper that may be inconsistent with its use of coding systems. Additionally or alternatively, the specific set of rules provide a technical improvement within the fintech field for managed accounts by automatically identifying fund categories and respective target allocations for an investment account based on characteristics of a participant and/or automatically selecting a best-performing fund for each of those fund categories. Additionally or alternatively, the specific set of rules provide a technical improvement within the historically-rigid operating framework of managed accounts by automatically selecting a fallback fund category and/or a combination of fallback fund categories that perform(s) most similarly to an unavailable fund category.

Examples disclosed herein each include one or more servers, including a database server and an application server. The application server is configured to collect a list of offered funds from an account manager and/or recordkeeper that includes identifier codes for respective offered funds. The application server then is configured to generate an available-funds table, which includes a list of funds available for a participant, based on the list of offered funds and using a fund database.

The fund database of the database server is configured to store information of previously-identified funds. For each previously-identified fund, the fund database is configured to store a fund category, one or more of the identifier codes, and one or more of the fund scores. The fund database is configured to store multiple identifier codes for a particular fund to enable available funds to be identified based on various code types (e.g., “SecID,” “Ticker,” and “Cusip”). The database server compares, in real-time, the identifier code of an offered fund to identifier codes of the various code types within the fund database in a cascading manner to determine whether the fund database includes a fund category and fund score information for that offered fund. The fund database enables one of many alternative scoring systems and/or other metrics to be used when selecting a fund based on scores. If the offered fund is identified, its information is added as an entry in the available-funds table.

The database server also includes an allocation database that has one or more allocation tables. Each allocation tables includes a plurality of cells, each cell corresponds with a target-allocation sub-table, and each target-allocation sub-table includes a distribution of target fund categories and respective target allocations. A target-allocation sub-table allocation is selected, in real-time, for the participant based on the age of the participant, the risk tolerance of the participant, and allocation methodology selection.

The application server is configured to, in real-time, select funds from the available-funds table for each of the target fund categories in the target-allocation sub-table. For example, the application determines how many funds within the available-funds table match or are designated for each target fund category. If the number of matching funds is one, the application server assigns the target allocation of that target fund category to the sole matching fund. If there are multiple matching funds in the available-funds table, the application server assigns the target allocation of that target fund category to the matching fund with the highest fund score and/or fund information ratio. The selection of only one available fund for a targeted fund category reduces overhead costs by limiting the number of funds that need to be traded by a recordkeeper. If there are no available funds that match the target fund category, the application server uses a fallback database to select fund(s) of one or more substitute fund categories.

The fallback table enables the personalized managed investment account to be resolved from a broad range of fund lineup submissions by taking advantage of fallback or “next best categories. The fallback table of the database server includes entries for one or more fallback fund categories (e.g., a primary fallback fund category, a secondary fallback fund category, etc.) for respective fund categories. Each fallback fund category is formed by one or more substitute fund categories. When the fallback fund category is formed by two or more substitute fund categories, the fallback table identifies a respective portion designated for each substitute fund category. A fallback fund category is selected for a target fund category when (1) there is no fund for the target fund category within the available-funds table and (2) there is an available fund within the available-funds table for each of the one or more substitute fund categories forming that primary fallback fund category. For each substitute find category forming the selected fallback fund category, the application server then assigns a respective portion of the target allocation that is designated for the target fund category to an available fund (e.g., selected due to being the sole or highest scoring available fund).

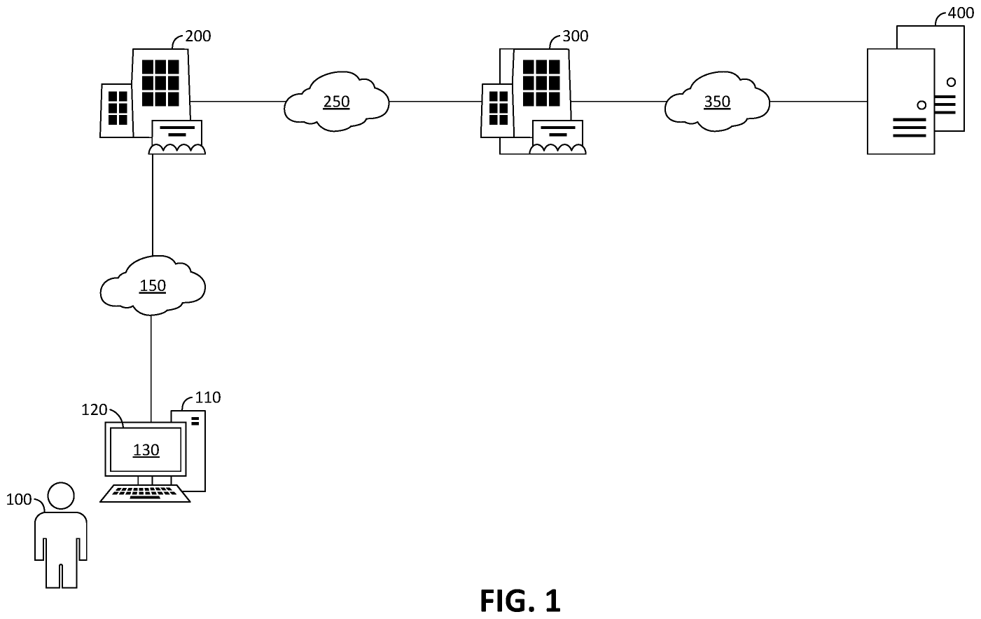

Turning now to the drawings, FIG. 1 depicts an example environment in which example fund allocation system 400 select fund allocations for managed investment accounts of participants in an automated manner. The environment also includes a participant 100 (also referred to as an “investor”), a recordkeeper 200, and an account management system 300.

A computer 110 of the participant 100 includes a display 120 and one or more input devices. The computer 110 may be a desktop, a laptop, a tablet, a smartphone, a smartwatch, etc. In the illustrated example, the computer 110 is communicatively connected to the recordkeeper 200 via a network 150. The recordkeeper 200 is communicatively connected to the account management system 300 via a network 250. The account management system 300 is communicatively connected to the fund allocation system 400 via a network 350. Each of the networks 150, 250, 350 may be a public network, such as the Internet, or a private network, such as an intranet. Further, in some examples, the network 150, the network 250, and/or the network 350 are combined as a single network (e.g., the Internet).

The participant 100 of the illustrated environment is investing in a managed investment account, such as a retirement account (e.g., a 401(k) offered by an employer, an IRA, etc.), an HSA, a 529 plan, a brokerage account, etc. The recordkeeper 200 is a party (e.g., a person, a company, etc.) that tracks assets of the managed investment account for the participant 100. The recordkeeper 200 may monitor, record, and/or report on user information (e.g., employee information), incoming money (e.g., from payroll), outgoing money (e.g., via a distribution of funds), in which funds the money is being invested, how much money that is invested in each fund, etc.

In some examples, the recordkeeper 200 operates a website (e.g., a user-facing web portal) that is accessible to the participant 100 via any Internet-enabled device, such as the computer 110. The website may enable the participant 100 to monitor aspects of their investment account. The website of the recordkeeper 200 may also be configured to collect information from the participant 100, such as age and risk tolerance, that is used to identify funds, such as age-based funds, for the participant 100.

The account management system 300 is configured to manage the managed investment account of the participant 100. For example, the account management system 300 may manage the distribution of the money of the participant 100 among various fund categories, the selection of funds for each of the various fund categories, etc. In the illustrated example, the account management system 300 is configured to operate web-based tools that enable the participant 100 to monitor information related to their managed investment account. For example, the account management system 300 is configured to operate a website 130 (e.g., a user-facing web portal) that is accessible to the participant 100 via any Internet-enabled device, such as the computer 110. The website 130 enables the account management system 300 to collect information from the participant 100 (e.g., a current age, a risk tolerance, an expected retirement age, a savings rate, demographics information, a list of outside investments, etc.) that is used to personalize the managed investment account of the participant 100. The website 130 enables the account management system 300 to provide information to the participant regarding the performance of the managed investment account.

The personalized information of the participant 100 and their managed investment account may be password-protected on the website 130. For example, the participant 100 may need to log on to a web portal of the website 130 using a username, a password, and two-factor authentication. In the illustrated example, the participant 100 is able to access information related to their managed investment account via a website of the recordkeeper 200. For example, the participant 100 logs on to the website of the recordkeeper 200 (e.g., using a username, a password, and two-factor authentication). The participant 100 then is directed to the website 130 of the account management system 300 upon selecting a digital button (e.g., a Review Your Strategy” button) or other link on the website of the recordkeeper 200. A single sign-on system is implemented such that the participant 100 is signed onto the website 130 of the account management system 300 upon selecting the button on the website of the recordkeeper 200. In other examples, the participant 100 may access information related to their managed investment account via a website of the fund allocation system 400.

The fund allocation system 400 is configured to select a personalized distribution of funds to optimize returns of the managed investment account for the participant 100. To create personalized distribution of funds for the managed investment account, the fund allocation system 400 is configured to select, in an automated manner, (1) fund categories and corresponding fund allocations based on characteristics of the participant 100 and (2) particular funds for those fund categories based on fund performance scores. In the illustrated example, the fund allocation system 400 is configured to receive, in real-time, characteristics of the participant 100, such as age and risk tolerance, from the account management system 300 via an application programming interface (API) and the network 350. For example, the fund allocation system 400 is configured to receive updated characteristics of the participant 100 in real-time as the participant 100 provides updated user information and/or changes settings on the website 130. The fund allocation system 400 is configured to then provide, in real-time via the API and the network 350, a list of funds and corresponding fund allocations to the account management system 300 to personalized the managed investment account of the participant 100. Subsequently, the account management system 300 instructs the recordkeeper 200, via the network 250, to invest in accordance with the personalized list of funds and corresponding fund allocations. In other examples, the fund allocation system 400 may send the personalized list directly to the recordkeeper 200.

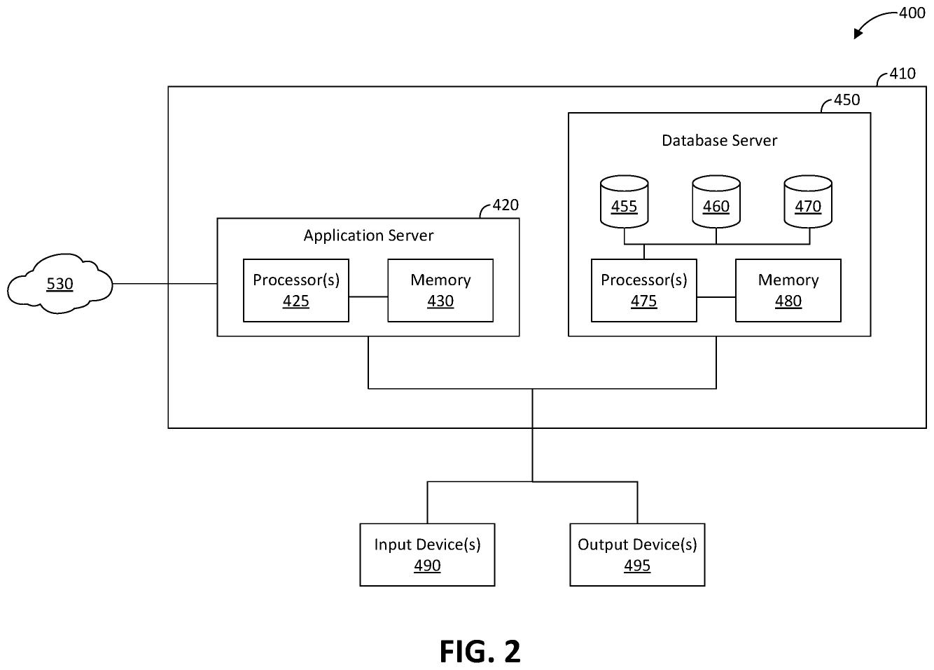

FIG. 2 depicts electronic components of the fund allocation system 400. The electronic components include one or more servers 410, one or more input devices 490, and one or more output devices 495. In the illustrated example, the server(s) 410 include an application server 420 and a database server 450.

The application server 420 is configured to (1) receive a list of offered funds 435 offered by the recordkeeper 200 from the account management system 300 via the API, (2) manage an available-funds table 440 that identify which of the offered funds is available for the participant, (3) select a list of funds from the available-funds table 440 to personalize the managed investment account of the participant 100, and (4) transmit, in real-time, a list of selected funds and corresponding fund allocations to the account management system 300 for the managed investment account of the participant.

In the illustrated example, the application server 420 includes one or more processor(s) 425 and memory 430. The processor(s) 425 (also referred to as “application processor(s)”) include any suitable processing device or set of processing devices such as, but not limited to, a microprocessor, a microcontroller-based platform, an integrated circuit, etc. The memory 430 is configured to store the software for operating the application server 420. The memory 430 may include volatile memory, non-volatile memory, unalterable memory, read-only memory, and/or high-capacity storage devices (e.g., hard drives, solid state drives, etc.). In some examples, the memory 430 includes multiple kinds of memory, such as a combination of volatile memory and non-volatile memory. The memory 430 is computer readable media on which one or more sets of instructions, such as the software for operating at least some of the methods of the present disclosure, can be embedded. The instructions may embody one or more of the methods or logic as described herein. For example, the instructions reside completely, or at least partially, within the memory 430, the processor(s) 425, and/or the application server 420 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The database server 450 is configured to manage and operate databases of the fund allocation system 400. The database server 450 of the illustrated example also includes one or more processors 475 and memory 480. The processor(s) 475 (also referred to as “database processor(s)”) include any suitable processing device or set of processing devices such as, but not limited to, a microprocessor, a microcontroller-based platform, an integrated circuit, etc. The memory 480 is configured to store the software for operating the database server 450. The memory 480 may include volatile memory, non-volatile memory, unalterable memory, read-only memory, and/or high-capacity storage devices (e.g., hard drives, solid state drives, etc.). In some examples, the memory 480 includes multiple kinds of memory, such as a combination of volatile memory and non-volatile memory. The memory 480 is computer readable media on which one or more sets of instructions, such as the software for operating at least some of the methods of the present disclosure, can be embedded. The instructions may embody one or more of the methods or logic as described herein. For example, the instructions reside completely, or at least partially, within the memory 480, the processor(s) 475, and/or the database server 450 during execution of the instructions.

In the illustrated example, the database server 450 includes a fund database 455, an allocation database 460, and a fallback database 470. In some examples, the database server 450 is a SQL database server and each of the fund database 455, the allocation database 460, and the fallback database 470 is a SQL database.

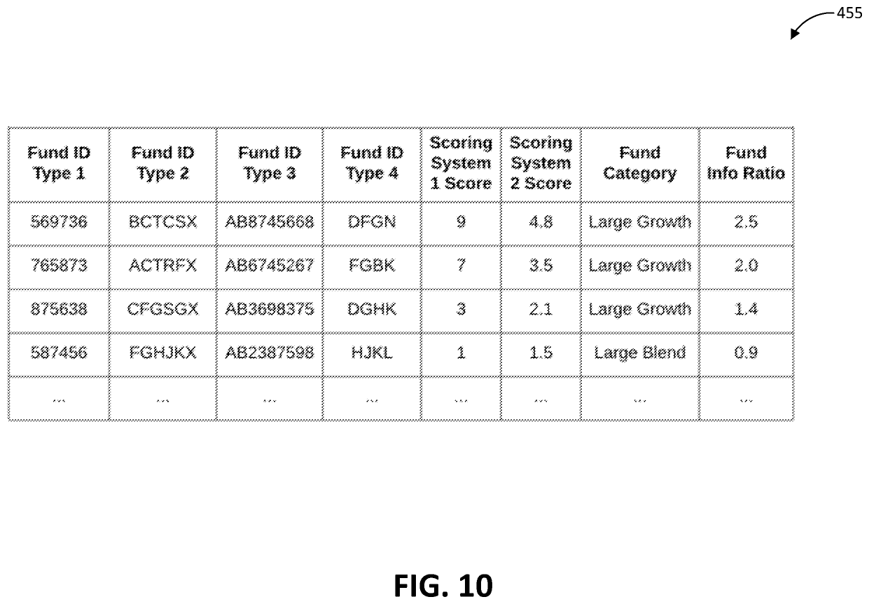

An example of the fund database 455 is shown in FIG. 10. Each row or entry of the fund database 455 corresponds with a respective fund. In some examples, the fund database 455 includes about 150,000 entries with each entry corresponding with a different fund. Each column of the fund database 455 corresponds with a particular characteristic of the funds. The fund database 455 of the illustrated example is configured to store one or more identifier codes, one or more fund scores, a fund category, and a fund information ratio for each of the fund entries.

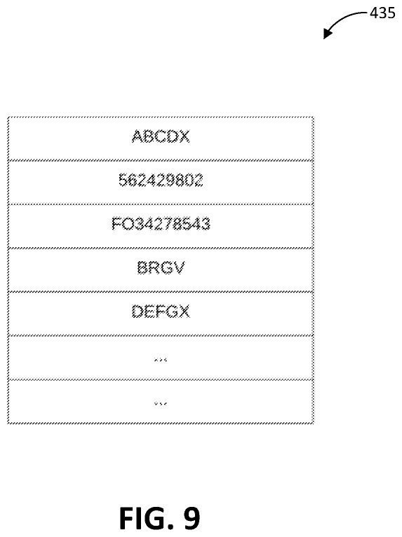

There are many different coding systems (e.g., Morningstar ID, CUSIP, Ticker, FIGI, PermID, LipperID, proprietary recordkeeper IDs, etc.) used to identify funds. As shown in FIG. 10, the first column of the fund database 455 corresponds with a first code type (“Fund ID Type 1”), the second column corresponds with a second code type (“Fund ID Type 2”), the third column corresponds with a third code type (“Fund ID Type 3”), and the fourth column corresponds with a fourth code type (“Fund ID Type 4”). In other examples, the fund database 455 may include columns for more or fewer code types. FIG. 9 depicts an example of the list of offered funds 435 of the recordkeeper 200 as it is received from the account management system 300. As shown in FIG. 9, the list of offered funds 435 may include a mix of different types of identifier codes. Returning to FIG. 10, the fund database 455 includes codes of many of those coding systems for the same fund to facilitate quick identification of each fund offered by the recordkeeper 200. As disclosed below in greater detail, each identifier code included in the list of offered funds 435 is compared to the identifier codes of the various code types stored in the fund database 455 in a cascading manner (e.g., initially check identifier codes of the first code type, then check identifier codes of the second code type, etc.) to quickly identify other details of the offered fund. In some instances, an identifier code of the list of offered funds 435 may be skipped or ignored if it does not match any identifier code stored in the fund database 455.

In the illustrated example of the fund database 455, the fifth column corresponds with a first scoring system (“Scoring System 1 Score”), the sixth column corresponds with a second scoring system (“Scoring System 2 Score”). In other examples, the fund database 455 may include columns for more or fewer scoring systems. The scoring systems assign a value to a fund that represents a score or grade of the performance of that fund. For example, a scoring system may assign a numerical value on a predefined scale (e.g., 0-10). In some examples, a scoring system included in the fund database 455 is created by a third party (e.g., Fi360). In other examples, the scoring system included in the fund database 455 is created by the fund allocation system 400. For example, the LeafHouse GPA system is a peer-to-peer fund ranking system created by LeafHouse Financial Advisors.

The LeafHouse GPA system is easily understandable and allows parties, such as fiduciaries, to quickly make informed decisions. For example, a score of 3.25-4.00 corresponds with an “A” grade that indicates a fund may be an appropriate choice for an investment account. A score of 2.5-3.25 corresponds with a “B” grade that indicates a fund already in use may not need to be replaced. A score of 1.75-2.5 corresponds with a “C” grade that indicates a fund has considerable shortfalls and may not be an appropriate choice. A score of 1.00-1.75 corresponds with an “F” grade that indicates a fund has significant shortfalls and may be an appropriate choice. In some examples, to calculate a score or grade for the Leafhouse GPA system, each fund is benchmarked to an appropriate index and sorted by peer group via fund category, each fund assigned a GPA for each respective scoring criteria, and scores are assigned by the funds percentile ranking among their peer group. Example criteria include a prospectus expense ratio, an annualized total return, a Sharpe ratio (comparing returns to volatility), an alpha metric (comparing excess risk adjusted returns to an index), a fund information ratio, a downside capture ratio (comparing fund performance to a market index during negative return periods), and an upside capture ratio (comparing fund performance to a market index during positive return periods). The Leafhouse GPA system may use an algorithm to balance current expenses, total returns, and risk-adjusted statistics with performance analysis over trailing time periods. The Leafhouse GPA system may use additional metrics pertaining to performance volatility, style purity, manager tenure, asset base, operating expenses, etc.

Additionally, in the illustrated example of the fund database 455, the seventh column corresponds with a fund category (“Fund Category”), and the eighth column corresponds with a fund information ratio (“Fund Info Ratio”). For each entry, the fund category data indicates for which fund category the respective fund is designated (e.g., “Large Blend,” “Large Growth”, “Large Value,” “Mid Cap Growth,” “Mid Cap Value,” “Stable Value,” “World Blend,” etc.). The fund information ratio measures a return of the fund compared to a benchmark, such as a market index, relative to a volatility of the return.

The fund database 455 may be updated intermittently and/or at predefined intervals (e.g., monthly, quarterly, etc.) to add new fund entries and/or to update information (e.g., fund scores) of existing entries. In some examples, the fund database 455 may be updated in an automated manner by the processor(s) 475 of the database server 450. Additionally or alternatively, an operator of the fund allocation system 400 may manually update and/or review the automated update of the fund database 455.

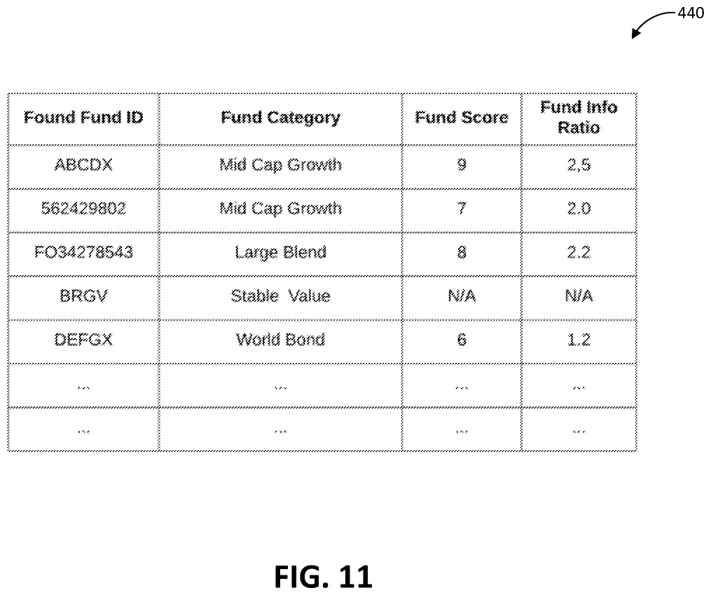

Once an offered fund is matched with an entry of the fund database 455 via an identifier code, information of the fund is added to the available-funds table 440. Each entry in the available-funds table 440 corresponds with a respective fund. In FIG. 11, the available-funds table 440 includes the matched identifier code (“Found Fund ID”), the fund category (“Fund Category”), one fund score (“Fund Score”), and the fund information ratio (“Fund Info Ratio”). When the fund database 455 includes scores of multiple scoring systems, the fund score included in the available-funds table 440 is based on a scoring system selection received from the account management system 300 and/or the recordkeeper 200.

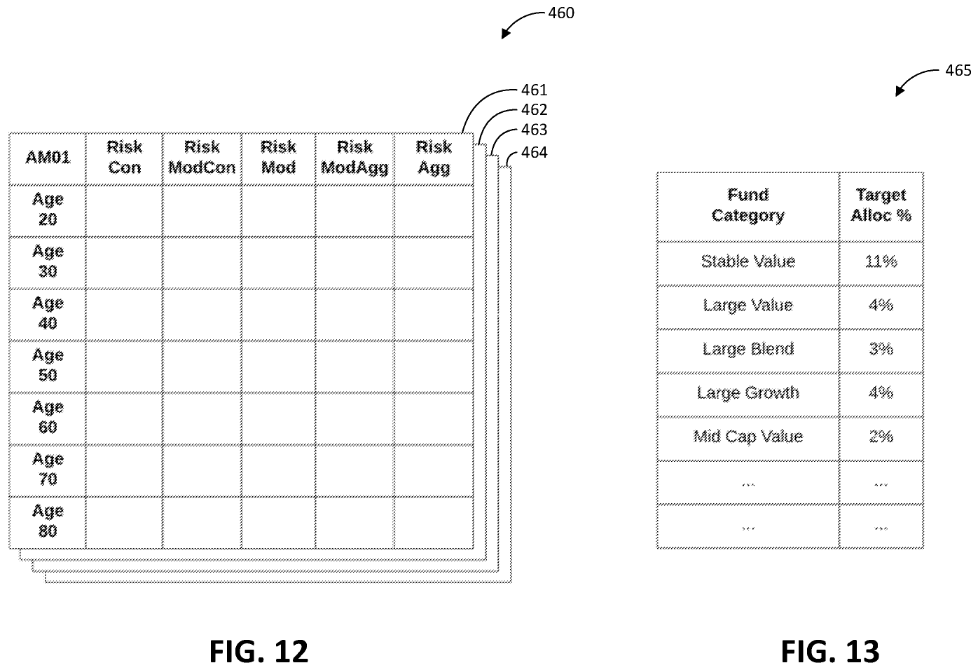

An example of the allocation database 460 is shown in FIG. 12. In the illustrated example, the allocation database 460 includes the plurality of allocation tables 461, 462, 463, 464. Each of the plurality of allocation tables 461, 462, 463, 464 corresponds with a different allocation methodology. That is, the allocation table 461 corresponds with a first allocation methodology, the allocation table 462 corresponds with a second allocation methodology, etc. A first allocation methodology may correspond with a combination of twelve different targeted fund categories, a second allocation methodology may correspond with a combination of fifteen different targeted fund categories, a third allocation methodology may correspond with a combination of five different targeted fund categories, a fourth allocation methodology may correspond with a combination of three different targeted fund categories, etc.

Within each of the allocation tables 461, 462, 463, 464, each row corresponds with a different age or age range. In the illustrated example, one row corresponds with age 20-29 (“Age 20”), another row corresponds with age 30-39 (“Age 30”), another row corresponds with age 40-49 (“Age 40”), etc. Additionally, each column corresponds with a different risk tolerance classification. In the illustrated example, the risk-tolerance classifications include conservative (“Risk Con”), moderate conservative (“Risk ModCon”), moderate (“Risk Mod”), moderate aggressive (“Risk ModAgg”), and aggressive (“Risk Agg”). Each of the allocation tables 461, 462, 463, 464 also includes a plurality of selectable cells. Each of the selectable cells corresponds with a particular combination of an allocation methodology, an age, and a risk tolerance. Additionally, each of the cells corresponds with or includes a respective target-allocation sub-table. For example, a particular target-allocation sub-table may be retrieved based on the selected allocation methodology, the age of the participant 100, and the risk tolerance of the participant 100.

The allocation database 460 may be updated intermittently and/or at predefined intervals (e.g., monthly, quarterly, etc.) to add new allocation table(s), change the fund categories associated with one or more existing allocation table(s), and/or to adjust the makeup of one or more target-allocation sub-tables. In some examples, the allocation database 460 may be updated in an automated manner by the processor(s) 475 of the database server 450. Additionally or alternatively, an operator of the fund allocation system 400 may manually update and/or review the automated update of the allocation database 460.

FIG. 13 depicts an example target-allocation sub-table 465 that has been selected from the allocation database 460. In the illustrated example, the target-allocation sub-table 465 includes one column of each of the fund categories of the selected allocation methodology and another column that identifies a respective target allocation for each of those fund categories. The target allocations are represented as percentages, and the sum of all the target allocations of the target-allocation sub-table 465 is 100%. The target allocations are preselected based on the age and risk-tolerance of the participant 100. For example, the target allocations for more aggressive fund categories are greater for younger and/or more risk-tolerant participants, while the target allocations for less aggressive fund categories are greater for older and/or more risk-averse participants. The target-allocation sub-table 465 may be updated intermittently and/or at predefined intervals (e.g., monthly, quarterly, etc.) to update target allocations designated for respective target fund categories. In some examples, the target-allocation sub-table 465 may be updated in an automated manner by the processor(s) 475 of the database server 450. Additionally or alternatively, an operator of the fund allocation system 400 may manually update and/or review the automated update of the target-allocation sub-table 465.

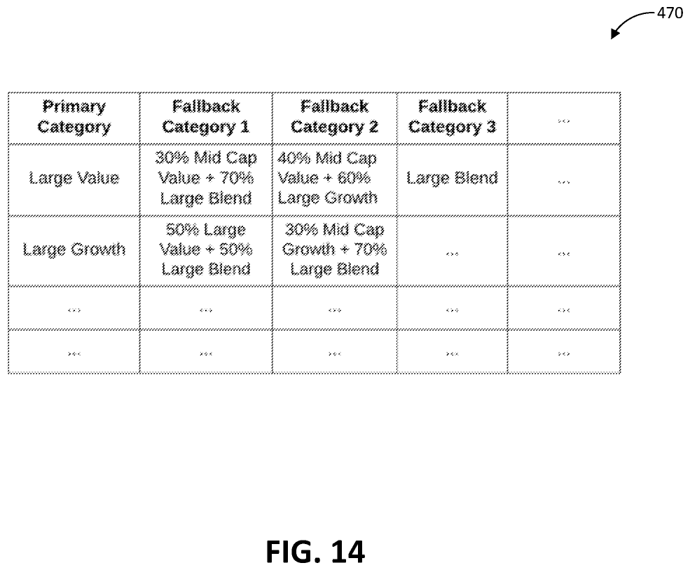

FIG. 14 depicts an example of the fallback database 470. In the illustrated example, each row corresponds with a fund category (e.g., “Large Value,” “Large Growth,” etc.), and each column corresponds with fallback category level (e.g., a primary fallback fund category, a secondary fallback fund category, a tertiary fallback fund category, etc.). The fallback database 470 also includes a plurality of selectable cells each of which includes a fallback fund category that corresponds with a corresponding fund category and a corresponding fallback category level. In some examples, the selected fallback fund category is formed by a single substitute fund category. In other examples, the fallback fund category is formed by a combination or blend of two or more substitute fund categories.

The fallback database 470 is accessed when the available-funds table 440 does not include a fund designated for one of the target fund categories included in the target-allocation sub-table 465. The fallback fund categories are designed to mimic the performance of the target fund category with no available fund such that the fallback database 470 enables the managed investment account to perform similarly to an account in which a fund was available for the corresponding target fund category. To increase how similar the fallback database 470 enables the managed investment account to perform, the fallback fund categories are ranked. The performance of the primary fallback fund category (“Fallback Category 1”) most closely resembles that of the target fund category, the performance of the secondary fallback fund category (“Fallback Category 2”) is the next closest in resembling the performance of the target fund category, the performance of the tertiary fallback fund category (“Fallback Category 3”) is the next closest in resembling the performance of the target fund category, etc.

The fallback fund categories are reviewed for a target fund category in a sequential manner. If the available-funds table 440 does not include a fund designated for a target fund category of the target-allocation sub-table 465, the primary fallback fund category is first reviewed. If the available-funds table 440 includes fund(s) designated for the one or more substitute fund categories forming the primary fallback fund category, fund allocation(s) are then assigned to those fund(s). Otherwise, if the available-funds table 440 does not include fund(s) designated for each of the one or more substitute fund categories forming the primary fallback fund category, the secondary fallback fund category is then reviewed in a similar manner. If the available-funds table 440 includes fund(s) designated for the one or more substitute fund categories forming the secondary fallback fund category, fund allocation(s) are then assigned to those fund(s). Otherwise, if the available-funds table 440 does not include fund(s) designated for each of the one or more substitute fund categories forming the secondary fallback fund category, the tertiary fallback fund category is then reviewed in a similar manner.

The fallback database 470 may be updated intermittently and/or at predefined intervals (e.g., monthly, quarterly, etc.) to add new fallback fund categories, to change which substitute fund categories form existing fallback fund categories, and/or to change percentages assigned to substitute fund categories of existing fallback fund categories. In some examples, the fallback database 470 may be updated in an automated manner by the processor(s) 475 of the database server 450. Additionally or alternatively, an operator of the fund allocation system 400 may manually update and/or review the automated update of the fallback database 470.

The output device(s) 495 of the illustrated example display output information and/or data of the application server 420 and/or the database server 450 to an operator of the fund allocation system 400. For example, the out device(s) 495 enable the operator to review, intermittently and/or at predefined intervals, entries within the fund database 455, the allocation database 460, and/or the fallback database 470. Examples of the output device(s) 495 include a display (e.g., a flat panel display, a liquid crystal display (LCD), an organic light emitting diode (OLED) display, etc.) and/or any other device that visually presents information to the operator. Additionally or alternatively, the output device(s) 495 may include one or more audio output devices (e.g., speakers) and/or haptic output device(s) for the operator.

The input device(s) 490 include one or more of a touchscreen, a touchpad, a keyboard, a mouse, a speech recognition system, a button, a control knob, etc. The input device(s) 490 of the illustrated example enable the operator of the fund allocation system 400 to provide and/or modify instructions and/or data for the application server 420 and/or the database server 450. For example, the input device(s) 490 enable the operator to update, intermittently and/or at predefined intervals, entries within the fund database 455, the allocation database 460, and/or the fallback database 470.

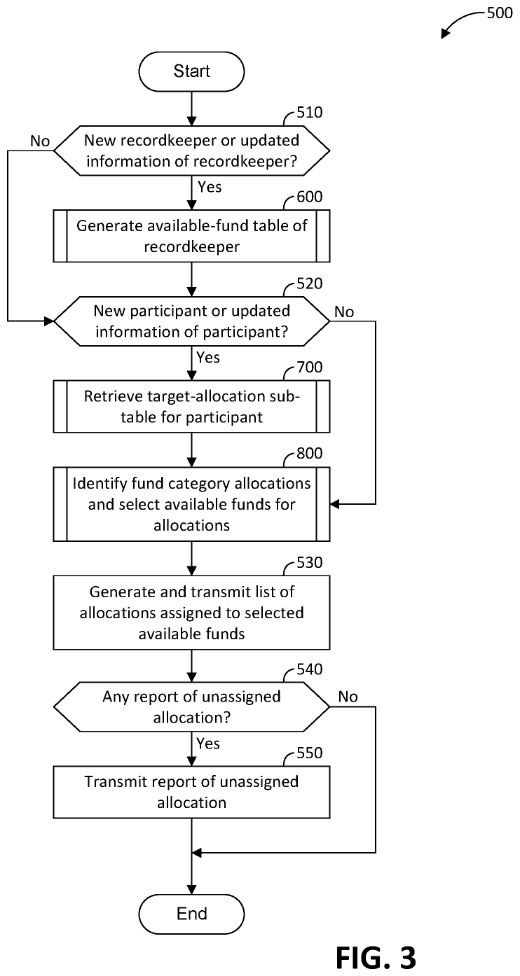

FIGS. 3-8 are flowcharts of an example method 500 to operate a system for selecting fund allocations for a managed investment account of a participant in an automated manner. The flowcharts of FIGS. 3-8 are representative of machine readable instructions that are stored in memory and include one or more programs which, when executed by processor(s) (such as the processor(s) 425 and/or the processor(s) 475 of FIG. 2), cause the fund allocation system 400 to select fund allocations in an automated manner. While the example method 500 is described with reference to the flowcharts illustrated in FIGS. 3-8, many other methods of selecting fund allocations in an automated manner may alternatively be used. For example, the order of execution of the blocks may be rearranged, changed, eliminated, and/or combined to perform the method 500. Further, because the method 500 is disclosed in connection with the components of FIGS. 1-2, some functions of those components will not be described in detail below.

Turning to FIG. 3, the method 500 begins at block 510 at which the processor(s) 425 of the application server 420 determine whether the application server 420 has received new or updated fund information from the recordkeeper 200 and/or another party with information related to offered funds. Example new or updated fund information includes a list of identifier codes of funds offered by the recordkeeper 200. The application server 420 may receive new fund information from the recordkeeper 200 when the fund allocation system 400 has yet to process funds offered by the recordkeeper 200. The application server 420 may receive updated fund information from the recordkeeper 200 when the recordkeeper 200 has updated fund information that was previously provided to the fund allocation system 400.

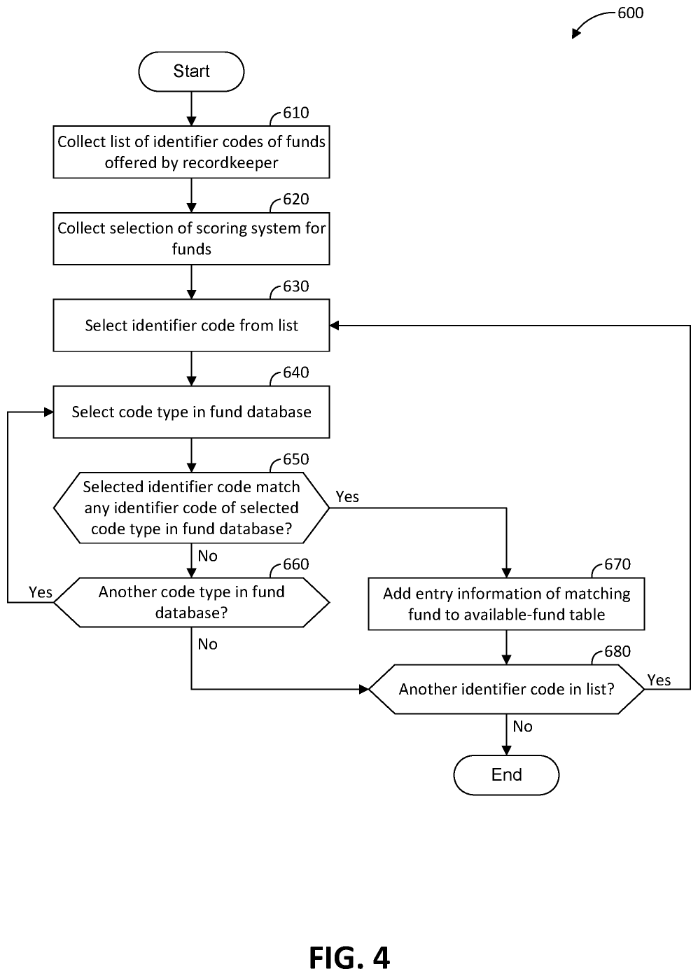

In response to the processor(s) 425 determining that the application server 420 has received new or updated fund information from the recordkeeper 200, the method 500 proceeds to block 600 at which the processor(s) 425 of the application server 420 generate the available-funds table 440 (FIG. 11) corresponding with the recordkeeper 200. A sub-process for generating the available-funds table 440 is disclosed below in further detail with respect to FIG. 4.

Otherwise, in response to the processor(s) 425 determining that the application server 420 has not received new or updated fund information from the recordkeeper 200, the method 500 proceeds to block 520 at which the processor(s) 475 of the database server 450 determines whether the database server 450 has received new or updated information regarding the participant 100 from the account management system 300, the recordkeeper 200, and/or the participant 100. Example new or updated participant information includes an age of, a risk tolerance of, and/or an allocation methodology selection for the participant 100. The database server 450 may receive new participant information when the fund allocation system 400 has yet to select funds for the participant 100. The database server 450 may receive updated participant information after initial participant information was previously provided to the fund allocation system 400.

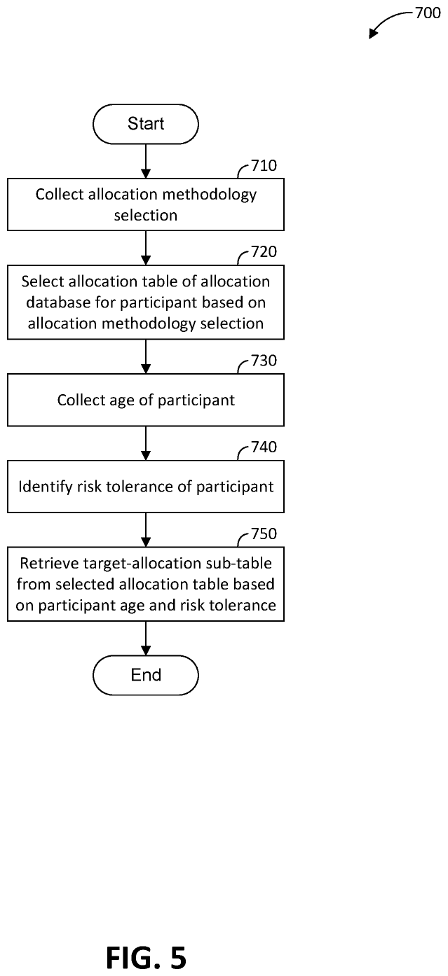

In response to the processor(s) 475 determining that the database server 450 has received new or updated participant information, the method 500 proceeds to block 700 at which the processor(s) 475 of the database server 450 retrieve the target-allocation sub-table 1500 (FIG. 13) corresponding with the participant 100. A sub-process for retrieving the target-allocation sub-table 1500 from the allocation database 1400 (FIG. 12) is disclosed below in further detail with respect to FIG. 5.

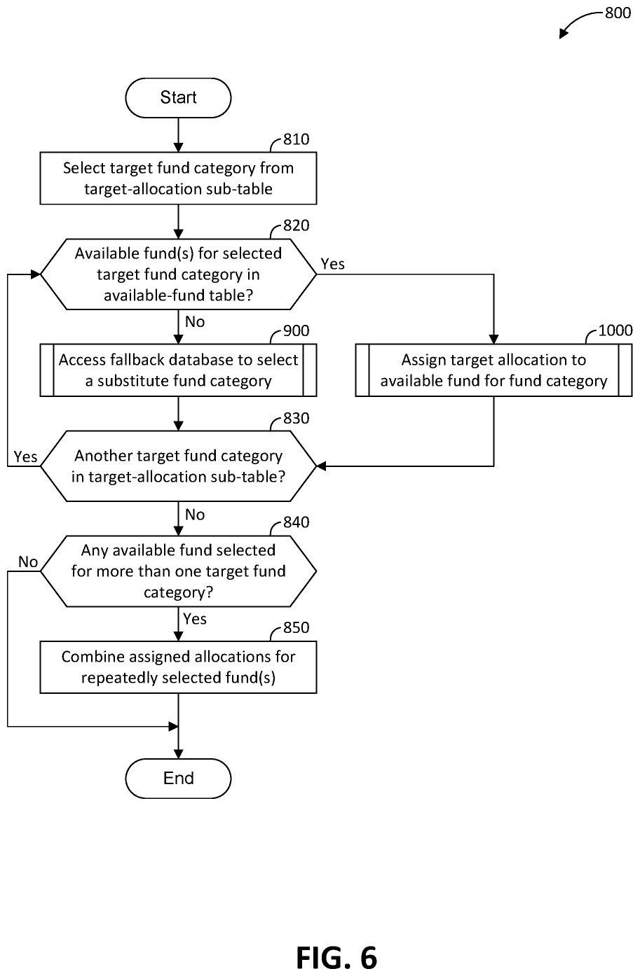

The method 500 proceeds to block 800 (1) upon completing block 700 or (2) in response to the processor(s) 475 determining that the database server 450 has not received new or updated participant information at block 520. At block 800, the processor(s) 425 of the application server 420 identify fund category allocations included in the target-allocation sub-table 1500 and select available funds from the available-funds table 440 for those fund category allocations. A sub-process for identifying the fund category allocations and subsequently selecting the available funds for those fund category allocations is disclosed below in further detail with respect to FIG. 6.

Upon completing block 800, the method 500 proceeds to block 530 at which the processor(s) 425 of the application server 420 generate an allocation list of the fund category allocations assigned to the selected available funds. The allocation list is used to instruct how money within the managed investment account of the participant should be distributed among the selected available funds. For example, the processor(s) 425 transmit the allocation list of the participant 100 to the account management system 300 via the API and the network 350. Provided below is example code JavaScript Object Notation (JSON) that is sent via the API to the account management system 300:

SecID: F00000Q7J4
Ticker: AULDX
Cusip: 02508H444
PrimaryCategory: Large Growth
FallbackCategory: Large Growth
FundGPA: 3.6
Fund3yrInfo: 1.309
FundAllocation: 4.500000
SecID: F00001CHLS
Ticker: WPGACX
Cusip: 97183W237
PrimaryCategory: Real Estate
FallbackCategory: Global Real Estate
FundGPA: 3.9
Fund3yrInfo: −1000
FundAllocation: 0.400000
SecID: F000013AJ3
Ticker: WTLRNX
Cusip: 97183K357
PrimaryCategory: Large Value
FallbackCategory: Large Value
FundGPA: 3.7
Fund3yrInfo: −0.938
FundAllocation: 4.500000
SecID: FOUSA00L5B
Ticker: VTMGX
Cusip: 921943809
PrimaryCategory: Foreign Large Blend
FallbackCategory: Foreign Large Blend
FundGPA: 3.1
Fund3yrInfo: 0.397
FundAllocation: 4.800000
SecID: F000014ZCL
Ticker: WMCAUX
Cusip: 97182E519
PrimaryCategory: Mid Cap Growth
FallbackCategory: Mid Cap Growth
FundGPA: 3.9
Fund3yrInfo: −1000
FundAllocation: 2.300000
SecID: F000010TVV
Ticker: FIWDX
Cusip: 315807420
PrimaryCategory: High Yield Bond
FallbackCategory: Multisector Bond
FundGPA: 3.4
Fund3yrInfo: 0.416
FundAllocation: 6.800000
SecID: F0000168YX
Ticker: WAAAGX
Cusip: 97182P142
PrimaryCategory: Mid Cap Value
FallbackCategory: Mid Cap Value
FundGPA: 2.4
Fund3yrInfo: −1000
FundAllocation: 2.300000
SecID: FOUSA00L83
Ticker: VTSAX
Cusip: 922908728
PrimaryCategory: Large Blend
FallbackCategory: Large Blend
FundGPA: 3.2
Fund3yrInfo: −0.168
FundAllocation: 3.200000
SecID: ZZZWPS0007
Ticker: 76133T759
Cusip: 76133T759
PrimaryCategory: Stable Value
FallbackCategory: Stable Value
FundGPA: 0
Fund3yrInfo: −1000
FundAllocation: 9.800000
SecID: F000002PJE
Ticker: RBFGX
Cusip: 097873814
PrimaryCategory: Intermediate Core Bond
FallbackCategory: Intermediate Core Bond
FundGPA: 3.5
Fund3yrInfo: 1.839
FundAllocation: 37.400000
SecID: F00001D1W0
Ticker:
Cusip: 97183C439
PrimaryCategory: World Bond
FallbackCategory: World Bond USD Hedged
FundGPA: 3.8
Fund3yrInfo: −1000
FundAllocation: 13.400000
SecID: F0000177YC
Ticker:
Cusip: 97183C140
PrimaryCategory: Small Growth
FallbackCategory: Small Growth
FundGPA: 3.6
Fund3yrInfo: −1000
FundAllocation: 0.600000
SecID: F000002PJ9
Ticker: RNWGX
Cusip: 649280815
PrimaryCategory: Diversified Emerging Mkts
FallbackCategory: Diversified Emerging Mkts
FundGPA: 3.8
Fund3yrInfo: 1.27
FundAllocation: 1.400000
SecID: FOUSA00G06
Ticker: PRRIX
Cusip: 693391104
PrimaryCategory: Inflation Protected Bond
FallbackCategory: Inflation Protected Bond
FundGPA: 3.5
Fund3yrInfo: 1.517
FundAllocation: 8.600000

Each grouping of code corresponds with a different available fund selected for one or more fund category allocations. In the example code, the portion of code for each of the selected available funds includes one or more identifier code types (e.g., “SecID,” “Ticker,” and “Cusip”), the corresponding target fund category (“PrimaryCategory”), a fallback fund category (“FallbackCategory”), one or more score types (“FundGPA” and “Fund3yrInfo”), and the allocation amount as a percentage (“FundAllocation”).

The account management system 300 then invests an amount of money corresponding with a fund category allocation to the respective selected available fund. For instance, if the managed investment account of the participant 100 includes $100,000 and the allocation for a fund category allocation is 5%, the account management system 300 invests $5,000 into the respective selected available fund for the participant 100. In other examples, the processor(s) 425 transmit the allocation list to another party, such as the participant 100, to instruct that other party how to distribute money of the managed investment account of the participant 100 among the selected available funds.

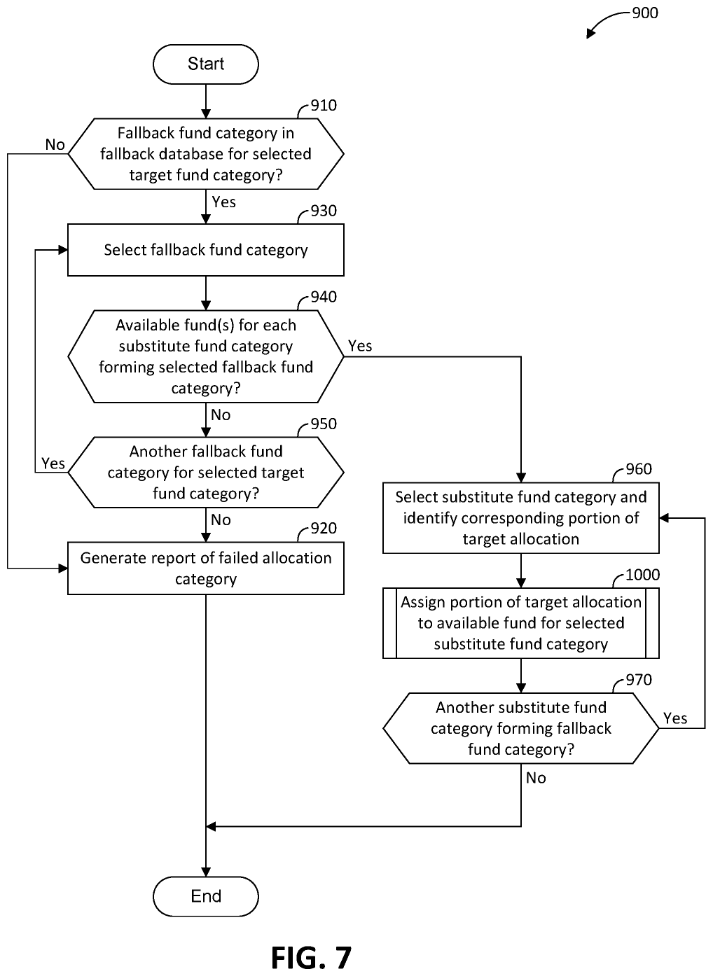

Upon completing block 530, the method 500 proceeds to block 540 at which the processor(s) 425 of the application server 420 determine whether any report has been generated for an unassigned fund category allocation. For example, as disclosed below in further detail with respect to block 950 of FIG. 7, the processor(s) 425 generate a report when the application server 420 is unable to identify any of the available funds for a target fund category. In response to the processor(s) 425 determining that no report has been generated for an unassigned fund category allocation, the method 500 ends. Otherwise, in response to the processor(s) 425 determining that one or more reports have been generated for unassigned fund category allocation(s), the method 500 proceeds to block 550 at which the processor(s) 425 transmit the report(s) notifying one or more parties of the unassigned fund allocation. For example, the processor(s) 425 transmit the report to the account management system 300 via the API to notify the account management system 300 that a portion of the managed investment account of the participant 100 has not been invested in funds offered by the recordkeeper 200. In some such examples, the account management system 300 subsequently informs the participant 100 that further plan setup is required and assigns that portion of the account to a placeholder identification code. Additionally or alternatively, the processor(s) 425 may transmit the report directly to the recordkeeper 200 and/or the participant 100 via a short message service (SMS) message, a multimedia messaging service (MMS) message, an email, and/or other messaging techniques. Upon completing block 550, the method 500 ends.

FIG. 4 is a flowchart of an example method 600 to perform the block 600 of FIG. 3 for generating the available-funds table 440 for the recordkeeper 200. Initially, at block 610, the processor(s) 425 of the application server 420 collect the list of offered funds 435 offered by the recordkeeper 200 and/or the account management system 300. The list of offered funds 435 include a list of identifier codes associated with funds offered by the recordkeeper 200. The list of identifier codes, as illustrated in FIG. 9, may include codes of different types and/or sources (e.g., Morningstar ID (also referred to as “SecID”), CUSIP, Ticker, FIGI, PermID, LipperID, proprietary recordkeeper ID, etc.). At block 620, the processor(s) 425 of the application server 420 and/or the processor(s) 475 of the database server 450 collect a selection of a scoring system for the funds. For example, the recordkeeper 200 selects a scoring system that it prefers for analysis of the offered funds. Example scoring systems include a Fund Score, which is a peer-to-peer fund ranking system generated by the fund allocation system 400; a scoring system provided by the recordkeeper 200; a scoring system, such as Fi360, that is generated by another third party; etc.

At block 630, the processor(s) 425 select one of the identifier codes included in the list of offered funds 435 (e.g., “ABCDX” as shown in FIG. 9). At block 640, the processor(s) 425 and/or the processor(s) 475 selects one of the code types included in the fund database 455. For example, the processor(s) 425 and/or the processor(s) 475 select “Fund ID Type 1” of the first column in the example fund database 455 of FIG. 10. At block 650, the processor(s) 425 and/or the processor(s) 475 determine whether the selected identifier code (e.g., ABCDX”) matches any identifier code of the selected code type (e.g., “Fund ID Type 1”) includes as part of any entry in the fund database 455.

In response to the processor(s) 425 and/or the processor(s) 475 determining that the fund database 455 does not include an entry with an identifier code of the selected code type that matches the selected identifier code, the method 600 proceeds to block 660 at which the processor(s) 425 and/or the processor(s) 475 identify whether there is another code type in the fund database 455 to review. In response to the processor(s) 425 and/or the processor(s) 475 identifying that there is another code type in the fund database 455 (e.g., “Fund ID Type 2,” “Fund ID Type 3,” “Fund ID Type 4,” etc.), the method 600 returns to block 640 to repeat block 640, block 650, and potentially block 660 for another code type. For example, the processor(s) 425 and/or the processor(s) 475 first repeat those blocks for a second code type (e.g., “Fund ID Type 2”) in the fund database 455. If the fund database 455 does not include an entry with an identifier code of the second code type that matches the selected identifier code, the method 600 may again repeat block 640, block 650, and potentially block 660 for a third code type. Blocks 640, 650, and 660 are repeated until the processor(s) 425 and/or the processor(s) 475 (1) determine at block 650 that the fund database 455 does include an entry with an identifier code that matches the selected identifier code or (2) identify at block 660 that there are no other code types in the fund database 455 to review.

Returning to block 660, the method 600 proceeds to block 680 in response to the processor(s) 425 and/or the processor(s) 475 identifying that there are no other code types in the fund database 455. Block 680 is discussed in further detail below.

Returning to block 650, the method 600 proceeds to block 670 in response to the processor(s) 425 and/or the processor(s) 475 determining that the fund database 455 does include an entry with an identifier code of the selected code type that matches the selected identifier code. At block 670, the processor(s) 425 add information of the matching fund entry from the fund database 455 and to the list of offered funds 435. As illustrated in FIG. 11, example information added as an entry to the list of offered funds 435 includes the selected identifier code (“Found Fund ID”), the corresponding fund category (“Fund Category”), a fund score of the selected scoring system (“Fund Score”), and the fund information ration (“Fund Info Ratio”). Upon completion of block 670, the method 600 proceeds to block 680.

At block 680, the processor(s) 425 of the application server 420 identifies whether there is another identifier code in the list of offered funds 435 to be reviewed. In response to the processor(s) 425 identifies that there is another identifier code in the list of offered funds 435 (e.g., “562429802,” “F034278543,” “BRGV”, and “DEFGX” as shown in FIG. 9), the method 600 returns to block 630. Otherwise, in response to the processor(s) 425 identifies that there are no other identifier codes in the list of offered funds 435, the method 600 of FIG. 4 ends.

FIG. 5 is a flowchart of an example method 700 to perform the block 700 of FIG. 3 for retrieving the target-allocation sub-table 465 from the allocation database 460 for the participant 100. Initially, at block 710, the processor(s) 475 of the database server 450 collect an allocation methodology selection. In some examples, the processor(s) 475 collect the allocation methodology selection from the account management system 300 via the API. In other examples, the processor(s) 475 collect the allocation methodology selection from the recordkeeper 200 and/or the participant 100. Each allocation methodology corresponds with a different combination of fund categories targeted for the managed investment account of the participant 100.

At block 720, the processor(s) 475 select an allocation table of the allocation database 460 base on the allocation methodology selection. In the illustrated example of FIG. 12, the allocation database 460 includes the plurality of allocation tables 461, 462, 463, 464 each of which corresponds with a different allocation methodology. For example, the allocation table 461 corresponds with the first allocation methodology such that the processor(s) 475 select the allocation table 461 when the first allocation methodology is selected, the allocation table 462 corresponds with the second allocation methodology such that the processor(s) 475 select the allocation table 462 when the second allocation methodology is selected, etc.

At block 730, the processor(s) 475 collect the age of the participant 100. In the illustrated example of FIG. 12, the age of the participant 100 falls within one of a plurality of predefined age categories. In some examples, the processor(s) 475 collect the participant's age from the account management system 300 via the API. In other examples, the processor(s) 475 collect the participant's age from the recordkeeper 200 and/or directly from the participant 100 via a web portal.

At block 740, the processor(s) 475 identify a risk tolerance of the participant 100. In some examples, the risk tolerance is represented by a numerical value on a predefined scale (e.g., from 1 to 5). In other examples, the risk tolerance is selected from one of a plurality of predefined risk-tolerance classifications. In some examples, the processor(s) 475 collect the risk tolerance of the participant 100 from the account management system 300 via the API. In other examples, the processor(s) 475 collect the risk tolerance from the recordkeeper 200 and/or directly from the participant 100 via a web portal. In other examples, the processor(s) 475 of the database server 450 and/or the processor(s) 425 of the application server 420 determine the risk tolerance of the participant 100 based on other data collected data of the participant 100, such as a current age, an expected retirement age, a savings rate, demographics information, a list of outside investments, etc.

At block 750, the processor(s) 475 of the database server 450 retrieves a target-allocation sub-table, such as the example target-allocation sub-table 465 of FIG. 13, from one of the allocation tables 461, 462, 463, 464 from the allocation database 460. As shown in FIG. 12, each of the allocation tables 461, 462, 463, 464 includes a plurality of selectable cells. Each of the selectable cells corresponds with a particular combination of an allocation methodology, an age, and a risk tolerance. Additionally, each of the cells corresponds with a respective target-allocation sub-table. For example, if the processor(s) 475 collect a selection of the first allocation methodology for the participant 100 with an age of 35 and a moderate risk tolerance, the processor(s) 475 select a cell and from the allocation table 461 that corresponds with an age of 35 and a moderate risk tolerance to select a target-allocation sub-table for the participant 100. As shown in FIG. 13, the target-allocation sub-table 465 identifies (1) each of the fund categories of the selected allocation methodology and (2) a respective target allocation for each of those fund categories.

FIG. 6 is a flowchart of an example method 800 to perform the block 800 of FIG. 3 for identifying fund category allocations in the target-allocation sub-table 465 and selecting available funds from the available-funds table 440 for the identified fund category allocations. Initially, at block 810, the processor(s) 425 of the application server 420 select a target fund category (e.g., “Stable Value”) from the example target-allocation sub-table 465 of FIG. 13 selected for the participant 100.

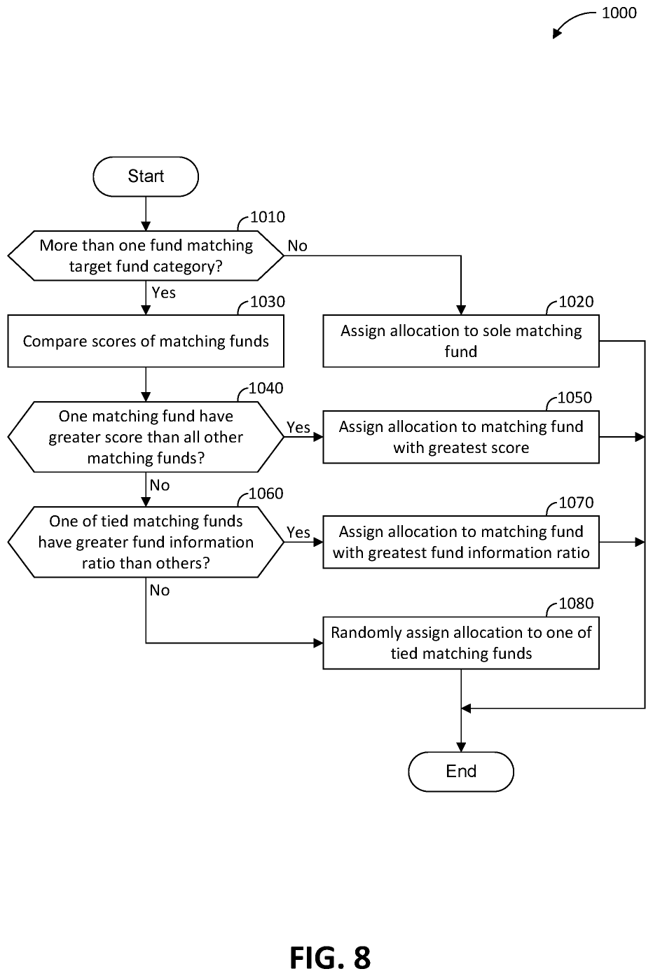

At block 820, the processor(s) 425 determine whether there are any available funds in the available-funds table 440 that are designated for the selected target fund category (e.g., “Stable Value”). In response to the processor(s) 425 identifying that there are no available funds in the available-funds table 440 designated for the selected target fund category, the method 800 proceeds to block 900 at which the processor(s) 425 of the application server 420 and/or the processor(s) 475 of the database server 450 access the fallback database 470 (FIG. 14) and select a fallback fund category as a replacement for the selected target fund category. A sub-process for accessing the fallback database 470 and select a fallback fund category is disclosed below in further detail with respect to FIG. 7. Otherwise, in response to the processor(s) 425 identifying that there is at least one available fund in the available-funds table 440 designated for the selected target fund category, the method 800 proceeds to block 1000 at which the processor(s) 425 assign the target fund allocation associated with the selected target fund category to one of the available fund(s) designated for the selected target fund category. A sub-process assigning a fund allocation to an available fund for a fund category is disclosed below in further detail with respect to FIG. 8.

Upon completion of block 900 or block 1000, the method 800 proceeds to block 830 at which the processor(s) 425 of the application server 420 determine whether there is another target fund category in the target-allocation sub-table 465. In response to the processor(s) 425 identifying another target fund category in the target-allocation sub-table 465 (e.g., “Large Value,” “Large Blend,” “Large Growth,” “Mid Cap Value”, etc.), the method returns to block 820 to repeat block 820, block 900 or block 1000, and block 830 for the other identified target fund category. Block 820, 900 and/or 1000, and 830 are repeated until all of the target fund categories in the target-allocation sub-table 465 have been reviewed for fund allocation.

Once the processor(s) 425 identify at block 830 that no other target fund category is in the target-allocation sub-table 465, the method proceeds to block 840 at which the processor(s) 425 determines whether any of the available funds have been selected for fund allocation for more than one target fund category. An available fund may be selected both (1) for the fund category for which it is designated (e.g., “Large Blend”) and (2) as the fallback fund category for another of the target fund categories. For example, the FO34278543 fund that is the third entry in the example available-funds table 440 of FIG. 11 may be selected both (1) for the “Large Blend” fund category for which it is designated and (2) as the third fallback fund category of the “Large Value” fund category that is the first entry in the example target-allocation sub-table 465 of FIG. 14. An available fund may also be selected as at least partially forming the respective fallback fund category for two or more of the target fund categories.

In response to the processor(s) 425 determining that none of the available funds have been selected for fund allocation for more than one target fund category, the method 800 ends. The processor(s) 425 then generate the allocation list of the fund category allocations assigned to the selected available funds at block 530 of FIG. 3 using the information of the selected available funds retrieved from the available-funds table 440 and the corresponding target allocation information retrieved from the target-allocation sub-table 465.

Otherwise, in response to the processor(s) 425 determining at block 840 that at least one of the available funds has been selected for fund allocation for more than one target fund category, the method 800 proceeds to block 850. At block 850, the processor(s) 425 combine the assigned allocations together for those available fund(s) that have been selected for fund allocation for more than one target fund category. Upon completion of block 850, the method 800 ends. The processor(s) 425 then generate the allocation list of the fund category allocations assigned to the selected available funds at block 530 of FIG. 3 using the information of the selected available funds retrieved from the available-funds table 440 and the target allocation information retrieved from the target-allocation sub-table 465.

FIG. 7 is a flowchart of an example method 900 to perform the block 900 of FIG. 6 for accessing the fallback database 1600 to select a fallback fund category for a target fund category that matches no available fund in the available-funds table 440. The method 900 is performed for each target fund category of the target-allocation sub-table 465 that does not have a matching available fund in the available-funds table 440. That is, the method 900 is performed when there is no available fund in the available-funds table 440 that is designated for a target fund category of the target-allocation sub-table 465.

Initially, at block 910, the processor(s) 425 of the application server 420 and/or the processor(s) 475 of the database server 450 determine whether there is any fallback fund category in the fallback database 470 for the target fund category that has no matching available fund. For example, the processor(s) 425 and/or the processor(s) 475 determine that there is a fallback fund category if the example fallback database 470 of FIG. 14 includes at least one fallback fund category (e.g., under “Fallback Category 1”) for the target fund category. The processor(s) 425 and/or the processor(s) 475 determine that there is no fallback fund category if the fallback database 470 includes no fallback fund category for the target fund category.

In response to the processor(s) 425 and/or the processor(s) 475 determining that there is no fallback fund category for the target fund category, the method 900 proceeds to block 920 at which the processor(s) 425 generate a report indicating that the portion of the managed investment account allocated for the target fund category has not been assigned to any fund. Upon completion of block 920, the method 900 ends for the target fund category that was selected at block 810 of FIG. 6. Additionally, the processor(s) 425 is to transmit the report to the account management system 300 and/or one or more other parties at block 550 of FIG. 3.

Returning to block 910 of FIG. 7, the method 900 proceeds to block 930 in response to the processor(s) 425 and/or the processor(s) 475 determining that there is at least one fallback fund category for the target fund category. At block 930, the processor(s) 425 and/or the processor(s) 475 select a fallback fund category from the fallback database 470 that is designated for the selected target fund category. For example, a primary fallback fund category (e.g., identified as “Fallback Category 1” in FIG. 14) is initially selected by the processor(s) 425 and/or the processor(s) 475.

At block 940, the processor(s) 425 and/or the processor(s) 475 determine whether there is an available fund for each substitute fund category that forms the selected fallback fund category. In the example fallback database 470 of FIG. 14, the primary fallback fund category for the “Large Value” fund category is formed from a combination or blend of two substitute fund categories, namely the “Mid Cap Value” fund category and the “Large Blend” fund category. In such an example, the processor(s) 425 and/or the processor(s) 475 determine whether the available-funds table 440 includes a fund designated for the “Mid Cap Value” fund category and another fund designated for the “Large Blend” fund category. If there are available funds for both the “Mid Cap Value” fund category and the “Large Blend” fund category, the processor(s) 425 and/or the processor(s) 475 determine that there is an available fund designated for each substitute fund category forming the selected fallback fund category. In contrast, if there is no available fund designated for the “Mid Cap Value” fund category and/or the “Large Blend” fund category, the processor(s) 425 and/or the processor(s) 475 determine that there is not an available fund designated for each substitute fund category forming the selected fallback fund category.

In response to the processor(s) 425 and/or the processor(s) 475 determining that there is not an available fund for each substitute fund category forming the selected fallback fund category, the method 900 proceeds to block 950 at which the processor(s) 425 and/or the processor(s) 475 determine whether there is another fallback fund category (e.g., a secondary fallback fund category, a tertiary fallback fund category, etc.) in the fallback database 470 for the target fund category that has no matching available fund. In response to the processor(s) 425 and/or the processor(s) 475 determining that there is no other fallback fund category for the target fund category, the method 900 proceeds to block 920 at which the processor(s) 425 generate a report indicating that the portion of the managed investment account allocated for the target fund category has not been assigned to any fund.

Otherwise, in response to the processor(s) 425 and/or the processor(s) 475 determining that there is another fallback fund category for the target fund category, the method 900 returns to block 930 to repeat block 930, block 940, and potentially block 950 for another one of the fallback fund categories. For example, the processor(s) 425 and/or the processor(s) 475 first repeat those blocks for a secondary fallback fund category (e.g., a fallback fund category listed under “Fallback Category 2”) in the fallback database 470. If the fallback database 470 does not include a secondary fallback fund category for the selected target fund category, the method 900 may again repeat block 930, block 940, and potentially block 950 for a tertiary fallback fund category (e.g., a fallback fund category listed under “Fallback Category 3”) in the fallback database 470. Blocks 930, 940, and 950 are repeated until the processor(s) 425 and/or the processor(s) 475 (1) determine at block 940 that there is an available fund for each substitute fund category forming a fallback fund category or (2) identify at block 950 that there are no other fallback fund categories in the fallback database 470 for the selected target fund category.

Returning to block 940, the method 900 proceeds to block 960 in response to the processor(s) 425 and/or the processor(s) 475 determining that there is an available fund in the available-funds table 440 for each substitute fund category forming a fallback fund category of the selected target fund category. At block 960 the processor(s) 425 and/or the processor(s) 475 select a substitute fund category forming the selected fallback fund category and identify a corresponding portion of the target allocation designated for the selected fallback fund category. In some examples, the selected fallback fund category is formed by a single substitute fund category. In such examples, the single substitute fund category is selected at block 960. In other examples, the selected fallback fund category is formed by a combination or blend of two or more substitute fund categories. In such examples, one of the plurality of substitute fund categories forming the fallback fund category is selected at block 960. Additionally, in the example fallback database 470 of FIG. 14, the portion of a target allocation designated for a particular substitute fund category is represented as a percentage. For example, the primary fallback fund category for the “Large Value” fund category indicates that (1) 30% of the target allocation for the “Large Value” fund category, as identified in the target-allocation sub-table 465, is designated for the “Mid Cap Value” fund category and (2) the remaining 70% of the target allocation for the “Large Value” fund category is designated for the “Large Blend” fund category.

Upon completion of block 960, the method 900 proceeds to block 1000 at which the processor(s) 425 assign the identified portion of the target fund allocation associated with the selected target fund category to an available fund designated for the selected substitute fund category. A sub-process assigning a fund allocation to an available fund for a fund category is disclosed below in further detail with respect to FIG. 8.

Upon completion of block 1000, the method 900 proceeds to block 970 at which the processor(s) 425 and/or the processor(s) 475 determines whether there is another substitute fund category that forms the selected fallback fund category. In response to the processor(s) 425 and/or the processor(s) 475 determining that there is another substitute fund category, the method 900 returns to block 960 to repeat blocks 960, 1000, 970 for the other substitute fund category. Otherwise, in response to the processor(s) 425 and/or the processor(s) 475 determining that there is not another substitute fund category, the method 900 ends for the target fund category that was selected at block 810 of FIG. 6.

FIG. 8 is a flowchart of an example method 1000 to perform the block 1000 of FIGS. 6 and 7 for assigning an allocation to an available fund for a fund category.

When the fund category is a target fund category, the method 1000 assigns the entire target allocation corresponding with the target fund category to an available fund. For example, when the processor(s) 425 determine at block 820 of FIG. 6 that there are available fund(s) in the available-funds table 440 designated for the selected target fund category (e.g., the “Stable Value” fund category), the method 1000 assigns the entire target allocation (e.g., 11%) identified in the target-allocation sub-table 465 for the selected target fund category.

When the fund category is the sole substitute fund category (e.g., the “Large Blend” fund category) forming a fallback fund category (e.g., the tertiary fallback fund category for the “Large Value” fund category), the method 1000 assigns the entire target allocation associated with the corresponding target fund category (e.g., 3% as identified in the target-allocation sub-table 465) to an available fund.

When the fund category (e.g., the “Mid Cap Growth” fund category) is one of a plurality of substitute fund categories that form a fallback fund category (e.g., the secondary fallback fund category for the “Large Growth” fund category), the method 1000 assigns a portion (e.g., 30% as identified in the fallback database 470) of the target allocation associated with the corresponding target fund category (e.g., 4% as identified in the target-allocation sub-table 465) to an available fund. In the above-provided example of the “Mid Cap Growth” fund category being one of a plurality of substitute fund categories, the method 1000 assigns an allocation of 1.2% (i.e., 30% of 4%) to the “Mid Cap Growth” fund category.

Initially, at block 1010, the processor(s) 425 of the application server 420 determine whether there is more than one available fund in the available-funds table 440 that is designated for the selected fund category. That is, the processor(s) 425 determine whether there (1) is only one available fund matching the selected fund category or (2) are multiple available funds matching from which to select for the selected fund category.

In response to the processor(s) 425 determining that there is a single available fund designated for the selected fund category, the method 1000 proceeds to block 1020 at which the processor(s) 425 assign the fund allocation for the fund category to the sole matching available fund within the available-funds table 440. Upon completion of block 1020, the method 1000 for assigning a fund allocation to an available fund for a selected fund category ends.

Otherwise, in response to the processor(s) 425 determining that there are multiple available funds in the available-funds table 440 that are designated for the selected fund category, the method 1000 proceeds to block 1030 at which the processor(s) 425 compare the fund scores stored in the available-funds table 440 for the matching available funds. At block 1040, the processor(s) 425 determine whether one of the matching available funds that are designated for the selected fund category has a greater fund score than the other matching available funds. For example, if (1) there are three available funds that are designated for the selected fund category and (2) one of those available funds has a fund score that is greater than that of the other two available funds, then the processor(s) 425 determine that one of the matching available funds does have a greater fund score than the other matching available funds. In contrast, if (1) there are three available funds that are designated for the selected fund category and (2) two of those available funds have the same fund score (i.e., are tied) that is greater than that of the third available fund, then the processor(s) 425 determine that one of the matching available funds does not have a greater fund score than the other matching available funds.

In response to the processor(s) 425 determining that one of the matching available funds does have a greater fund score than the other matching available funds, the method proceeds to block 1050 at which the processor(s) 425 assign the fund allocation for the fund category to the matching available fund that has the greatest fund score. Upon completion of block 1050, the method 1000 for assigning a fund allocation to an available fund for a selected fund category ends.

Returning to block 1040, the method 1000 proceeds to block 1060 in response to the processor(s) 425 determining that one of the matching available funds does not have a greater fund score than the other matching available funds. That is, the method 1000 proceeds to block 1060 in response to the processor(s) 425 determining that there is a tie for the greatest fund score among the available funds designated for the selected fund category.

At block 1060, the processor(s) 425 determine whether one of the matching available funds that are tied for the greatest fund score has a fund information ratio that is greater than the other available funds having the same fund score. The processor(s) 425 retrieve the fund information ratio for each of those available funds from the available-funds table 440. In response to the processor(s) 425 determining that one of those matching available funds has a fund information ratio that is greater than the other available funds having the same fund score, the method 1000 proceeds to block 1070 at which the processor(s) 425 assign the fund allocation for the fund category to the matching available fund that (1) is tied for having the greatest fund score and (2) has the greatest fund information ratio among the tied matching available funds. Otherwise, in response to the processor(s) 425 determining that none of the tied matching available funds has a fund information ratio that is greater than the other tied matching available funds, the method 1000 proceeds to block 1080 at which the processor(s) 425 assign the fund allocation for the fund category to a randomly selected one of the matching available funds that is tied for having the greatest fund score and the greatest fund information ratio. Upon completion of block 1070 or block 1080, the method 1000 for assigning a fund allocation to an available fund for a selected fund category ends.

While specific examples have been described in detail, it will be appreciated by those skilled in the art that various modifications and alternatives to those details could be developed in light of the overall teachings of the disclosure. Accordingly, the disclosure herein is meant to be illustrative only and not limiting as to its scope and should be given the full breadth of the appended claims and any equivalents thereof.

What is claimed is:

1. An automated system for selecting fund allocations for an investment account, the automated system comprising:
a database server including:
an allocation database having one or more allocation tables, wherein each of the one or more allocation tables includes a plurality of cells, wherein each of the plurality of cells includes a target-allocation sub-table that includes target fund categories and respective target allocations;
a fallback database that includes fallback fund categories for the target fund categories, wherein one or more of the fallback fund categories is designated for each of the target fund categories, and wherein, for each target fund category, each corresponding fallback fund category is formed from one or more substitute fund categories; and
one or more database processors configured to, in real-time upon a request for a participant:
collect an age of the participant;
determine a risk tolerance of the participant; and
retrieve a selected target-allocation sub-table from the allocation database based on, at least in part, the age and the risk tolerance of the participant; and
an application server including:
memory configured to store an available-funds table that includes an identifier code, a fund category, and a fund score for each available fund; and
one or more application processors, wherein the one or more application processors is configured to, in real-time upon the request for the participant:
for each of the target fund categories in the selected target-allocation sub-table:
determine a number of matching funds within the available-funds table that correspond with the target fund category;
in response to determining the number of matching funds being one, assign a target allocation for the target fund category to a sole matching fund;
in response to determining the number of matching funds being two or more, select a selected matching fund based on a comparison of the fund score of each matching fund and assign the target allocation to the selected matching fund;
in response to determining the number of matching funds being zero, select a selected fallback fund category from the fallback database and assign the target allocation among the one or more substitute fund categories that form the selected fallback fund category; and
generate and transmit an allocation list that identifies an allocation amount assigned to each available fund selected for fund allocation.

2. The automated system of claim 1, wherein each of the one or more allocation tables of the allocation database corresponds with a different combination of fund categories.

3. The automated system of claim 2, wherein the one or more database processors is configured to:
collect an allocation methodology selection;
select a selected allocation table from the one more allocation tables based on the allocation methodology selection; and
retrieve the selected target-allocation sub-table from the selected allocation table.

4. The automated system of claim 1, wherein the one or more application processors of the application server is configured to collect a list of offered funds and generate the available-funds table based on the list of offered funds, wherein the list of offered funds includes identifier codes for respective offered funds.

5. The automated system of claim 4, wherein the database server further includes a fund database configured to store fund categories, identifier codes, and fund scores for identifiable funds, wherein the fund database is configured to store a fund category, one or more of the identifier codes, and one or more of the fund scores for each of the identifiable funds.

6. The automated system of claim 5, wherein, for each offered fund within the list of offered funds, the one or more database processors is configured to:
identify the offered fund by comparing the identifier code of the offered fund to the identifier codes stored within the fund database; and
add the identifier code, the fund category, and one of the one or more fund scores of the offered fund that has been identified to the available-funds table.

7. The automated system of claim 6, wherein the fund database is configured to include a plurality of fund code types, and wherein, to identify each offered fund, the one or more database processors are configured to:
compare the identifier code of the offered fund to the identifier codes of a first fund code type that are stored within the fund database; and
in response to determining that the identifier code of the offered fund does not match any of the identifier codes of the first fund code type, compare the identifier code of the offered fund to the identifier codes of another fund code type that are stored within the fund database.

8. The automated system of claim 6, wherein the fund database is configured to include a plurality of scoring systems, and wherein the one or more database processors are configured to collect a scoring system selection and select which of the one or more fund scores to add to the available-funds table based on the scoring system selection.

9. The automated system of claim 1, wherein, to select the selected matching fund for one of the target fund categories, the one or more application processors is configured to select a first matching fund that has a greatest score among matching funds as the selected matching fund for allocation.

10. The automated system of claim 9, wherein, in response to determining that two or more of the matching funds are tied for having the greatest score among the matching funds, the one or more application processors is configured to compare fund information ratios of the two or more of the matching funds as a tiebreaker to select the selected matching fund for allocation.

11. The automated system of claim 10, the one or more application processors is configured to randomly select the selected matching fund for allocation in response to identifying a tie between the fund information ratios.

12. The automated system of claim 1, wherein the fallback database includes a respective primary fallback fund category for each of the target fund categories and includes a respective secondary fallback fund category for one or more of the target fund categories.

13. The automated system of claim 1, wherein the substitute fund categories of the fallback database include one or more of the target fund categories, and wherein one or more of the fallback fund categories includes a combination of two or more of the substitute fund categories each of which is designated a portion of the target allocation for the respective target fund category.

14. The automated system of claim 1, wherein, for each of the target fund categories, the one or more database processors is configured to:
select a primary fallback fund category in response to the one or more application processors determining that the available-funds table includes an available fund for each of the one or more substitute fund categories that form the primary fallback fund category;
determine whether to select a secondary fallback fund category in response to the one or more application processors determining that there is no available fund in the available-funds table for at least one of the one or more substitute fund categories forming the primary fallback fund category; and
select the secondary fallback fund category in response to the one or more application processors determining that the available-funds table includes an available fund for each of the one or more substitute fund categories that form the secondary fallback fund category.

15. The automated system of claim 1, wherein, in response to determining that an available fund is selected for two or more of the target fund categories, add the corresponding allocation amounts together when generating the allocation list.

16. An automated method for selecting fund allocations for an investment account, the automated method comprising:
operating an allocation database of a database server, wherein the allocation database has one or more allocation tables, wherein each of the one or more allocation tables includes a plurality of cells, wherein each of the plurality of cells includes a target-allocation sub-table that includes target fund categories and respective target allocations;
operating a fallback database of the database server, wherein the fallback database includes fallback fund categories for the target fund categories, and wherein one or more of the fallback fund categories is designated for each of the target fund categories, wherein, for each target fund category, each corresponding fallback fund category is formed from one or more substitute fund categories;
collecting, via one or more database processors of the database server, an age of a participant in real-time upon a request for the participant;
determining, via the one or more database processors, a risk tolerance of the participant in real-time upon the request for the participant;
retrieving, in real-time upon the request for the participant, a selected target-allocation sub-table from the allocation database based on, at least in part, the age and the risk tolerance of the participant;
storing, in memory of an application server, an available-funds table that includes an identifier code, a fund category, and a fund score for each available fund;
for each of the target fund categories in the selected target-allocation sub-table and in real-time upon the request for the participant:
determining, via one or more application processors of the application server, a number of matching funds within the available-funds table that correspond with the target fund category;
in response to the number of matching funds being one, assigning a target allocation for the target fund category to a sole matching fund;
in response to the number of matching funds being two or more, selecting a selected matching fund based on a comparison of the fund score of each matching fund and assigning the target allocation to the selected matching fund; and
in response to the number of matching funds being zero, selecting a selected fallback fund category from the fallback database and assigning the target allocation among the one or more substitute fund categories that form the selected fallback fund category; and
generating and transmitting, via the one or more application processors, an allocation list that identifies an allocation amount assigned to each available fund selected for fund allocation.

17. The automated method of claim 16, wherein selecting the selected matching fund for one of the target fund categories includes:
selecting a first matching fund that has a greatest score among matching funds as the selected matching fund for allocation;
in response to determining that two or more of the matching funds are tied for having the greatest score among the matching funds, comparing fund information ratios of the two or more of the matching funds as a tiebreaker to select the selected matching fund for allocation; and
randomly selecting the selected matching fund for allocation in response to identifying a tie between the fund information ratios.

18. The automated method of claim 16, wherein the substitute fund categories of the fallback database include one or more of the target fund categories, and wherein one or more of the fallback fund categories includes a combination of two or more of the substitute fund categories each of which is designated a portion of the target allocation for the respective target fund category.

19. The automated system of claim 16, further including, for each of the target fund categories:
selecting a primary fallback fund category in response to determining that the available-funds table includes an available fund for each of the one or more substitute fund categories that form the primary fallback fund category;
determining whether to select a secondary fallback fund category in response to determining that there is no available fund in the available-funds table for at least one of the one or more substitute fund categories forming the primary fallback fund category; and
selecting the secondary fallback fund category in response to the one or more application processors determining that the available-funds table includes an available fund for each of the one or more substitute fund categories that form the secondary fallback fund category.

20. Computer readable media comprising instructions, which, when executed, cause one or more machines to collectively:
operate an allocation database of a database server, wherein the allocation database has one or more allocation tables, wherein each of the one or more allocation tables includes a plurality of cells, wherein each of the plurality of cells includes a target-allocation sub-table that includes target fund categories and respective target allocations;
operate a fallback database of the database server, wherein the fallback database includes fallback fund categories for the target fund categories, wherein one or more of the fallback fund categories is designated for each of the target fund categories, and wherein, for each target fund category, each corresponding fallback fund category is formed from one or more substitute fund categories;
collect an age of a participant in real-time upon a request for the participant;
determine a risk tolerance of the participant in real-time upon the request for the participant;
retrieve, in real-time upon the request for the participant, a selected target-allocation sub-table from the allocation database based on, at least in part, the age and the risk tolerance of the participant;
store an available-funds table that includes an identifier code, a fund category, and a fund score for each available fund;
for each of the target fund categories in the selected target-allocation sub-table and in real-time upon the request for the participant:
determine a number of matching funds within the available-funds table that correspond with the target fund category;
in response to the number of matching funds being one, assign a target allocation for the target fund category to a sole matching fund;
in response to the number of matching funds being two or more, select a selected matching fund based on a comparison of the fund score of each matching fund and assign the target allocation to the selected matching fund; and
in response to the number of matching funds being zero, select a selected fallback fund category from the fallback database and assign the target allocation among the one or more substitute fund categories that form the selected fallback fund category; and
generate and transmit an allocation list that identifies an allocation amount assigned to each available fund selected for fund allocation.
